(19) United States
(12) Patent Application Publication
(10) Pub. No.: US 2024/0212038 A1
(43) Pub. Date: Jun. 27, 2024

(54) PRE-LEGAL CHILD SUPPORT MANAGEMENT SYSTEM AND METHOD

(71) Applicant: Rodney Allen, Hollywood, FL (US)

(72) Inventor: Rodney Allen, Hollywood, FL (US)

(21) Appl. No.: 18/087,927

(22) Filed: Dec. 23, 2022

(51) Int. Cl. G06Q 40/02; G06Q 20/06; G06Q 20/22; G06Q 20/34; G06Q 20/38; G06Q 20/40

(52) U.S. Cl. CPC G06Q 40/02; G06Q 20/065; G06Q 20/2295; G06Q 20/354; G06Q 20/3572; G06Q 20/389; G06Q 20/401; G06Q 20/405; G06Q 2220/00

(57) ABSTRACT

A system and method for managing prelegal child support payments is disclosed. The system includes at least one processor and a memory. The memory stores an amount of child support to be provided by the non-custodial parent to a custodial parent. The system further includes a system bank account associated with, and managed from, a non-custodial parent user account. The system issues a debit card to at least one of the custodial parent and non-custodial parent. The debit card(s) is linked to the system bank account. The system calculates a child support balance after deducting each purchase made with the debit card(s).

### FIELD OF THE INVENTION

The present invention relates to computer-implemented support systems, and more particularly, to a pre-legal child support management system and method of using the same.

### BACKGROUND OF THE INVENTION

Unwed biological fathers are originally putative fathers, unsure of biological relations. A “putative father” is defined as a man who has no legally established relationship to a child, but who either claims to be the biological father of the child, or who is alleged to be the biological father of the child as claimed by the mother. Putative fathers have historically experienced difficulties accessing, supporting, or having a meaningful relationship with their children. Current laws give the mother of a child born out of wedlock natural guardianship of a child and entitlement to primary residential care and custody. This is done without completing a “social investigation” to determine which parent is the more fit parent and best for the interest of the child. Many estranged fathers feel emasculated being reduced to financial contributors and, in many cases, abandoning their parental responsibilities while making an estimated $148 billion annually in undocumented child support, which includes, but is not limited, to monetary monthly payments. Often, these payments are considered gifts without putative fathers having a stated intent or purpose for expenses, purchases, and payments. This often results in accumulating back pay child support (arrearages) as well as excessive child support amounts when a child support order is later placed on a putative father. This is due to the calculations of the Income Shares Model which is used in 41 States across the U.S. The amount of child support that is to be paid by either parent is affected by the total overnight visitations a child spends with each parent per calendar year.

Although there is an increased interest in putative fathers who intend on pursuing a parental interest or who actively co-parent with allowed, limited access given by mothers, there are underlying causes that deter fathers from legally establishing a parental interest. The legal framework itself is intimidating to many putative fathers and often serves as a barrier due to there being no federal law in place that regulates putative father registries. For instance, the U.S. has not ratified the Convention on the Rights of the Child and registries under the U.N. Charter. Article #7 of the convention states that a child shall be registered immediately after birth and shall have the right from birth to know and be cared for by his or her parents. In the U.S., most States require an unwed biological father to legally establish a parental interest to a child. Prior art child support management systems do not address the millions of putative fathers not protected under the U.S. constitution and separated from their children.

### Problems the Invention Intends to Solve

Prior art systems reflect coparenting relationships after legal proceedings have taken place. Ex: Prior art comprises of computer-implemented support systems, and more particularly, child support management systems that enables only parents to enter data such a receipt into a central repository, essentially assuming a putative father acknowledges and accepts his role a parent, communicating and exchanging child expenses along with other matters related to the child. None of these systems provide for where a man is unsure if he is indeed the biological father and who only wishes to temporarily act as a father until paternity is established.

Various computer-implemented systems and methods for managing child support payments are identified in the following Patents Documents 1-3:

Patent Document 1: U.S. Pat. No. 8,065,159 issued on Nov. 22, 2011, titled “System, method and article of manufacture for a network-based child support framework.” Patent Document 1 discloses a web application that allows case participants (i.e., parents) to inquire about the status of their support cases. (Col. 2, lines 57-63.) Through the web application, custodial and non-custodial parents are granted access to information which was previously only available to specially trained state agency staff using dedicated computer terminals connected directly to intra-agency computer systems. (Col. 2, lines 63-67.) The web application actively engages custodial parents in the management of their cases (Col. 3, lines 1-2). For instance, the web application allows the custodial parent to retrieve tracking information for the financial support payment, including payment status, payment amount due, payment amount received, payment date, and payment available withdrawal date. (Claim 1.)

Patent Document 2: US 20130066754 A1 published on Mar. 14, 2013, titled “Child support management system and method.” Patent Document 2 describes that the non-custodial parent must often pay, as part of their child support obligation, reimbursement for incremental expenses as well as critical additional expenses such as health care, education expenses, child care or any other additional expenses incurred to support the child. (Paragraph 3.) Once a child support order or agreement has been established, the parents of the child conventionally have two options to manage the payment of child support. The first option is to use a government child support agency. The second option is to manage the payments manually. According to Patent Document 2, the state government agencies are ineffective because each state system is built on a unique and proprietary infrastructure that cannot communicate with other infrastructures. In addition, the state systems do not manage incremental expenses. (Paragraph 4.) According to Patent Document 2, manually managing child support payments, including reimbursements, etc., is complicated and disruptive, leading to many financial disagreements between the parents. (Paragraph 4.) Patent Document 2 solves the foregoing problem by providing an online child support management system that tracks expenses—e.g., uploaded receipts requiring manually entered transaction info or automatic entering of the expenses based upon previously (manually) entered party information and credentials (Paragraph 18)—and automatically calculates remaining balance of child support owed and communicates the same to both parents. (Paragraph 6.) Sometimes the custodial parent will pay more than their share of an expense, while other times it will be the non-custodial parent. The online child support management system will calculate these expenses and present the totality of payments and expenses to both parents in a way that is clear and easy to understand. Thus, Patent Document 2 facilitates improved communication between divorced parents regarding child support related expenses and payments, including, but not limited to, incremental and additional expenses that are bi-directional and between both parents (or between one parent and a third party).

Patent Document 3: U.S. Ser. No. 10/997,601 issued on May 4, 2021, titled “Methods and Systems for Child Support Payment.” Patent Document 3 discloses methods and systems for enabling a non-custodial parent to purchase goods and service directly from merchants for a child while getting acknowledgement and consideration under a government child support program for the purchased goods and services. (Abstract.) The method requires that the relevant government agency overseeing the child support payments, the custodial parent, the non-custodial parent and the merchant are all interconnected via a “direct support” (DS) system. (Col. 5, lines 56-59.) A unique ID is generated for both the custodial parent and the non-custodial parent, and a common account is created for both the custodial parent and the non-custodial parent with a merchant using the unique ID. (Abstract.) In an example embodiment, the custodial parent accesses the merchant website by logging in using a username and the unique ID provided at the time of registration with the DS system. The custodial parent selects items or services required for the child and adds them in a product card of the merchant web site. After adding the items or services, the custodial parent logs out from the merchant website. The non-custodial parent (who is notified of the intended purchase) also accesses the merchant website by logging in using the username and the unique ID provided at the time of registration with the DS system. The non-custodial parent checks the product cart and decides goods or services for which payment should be made, based on the added goods and services by the custodial parent. Post payment of the goods or services, the merchant generates an obligation fulfilment file related to the purchase of the goods or services and sends it to the DS system. The DS system then transmits the information to the relevant government agency, whereby the non-custodial parent is credited the foregoing purchase against the child support obligation. (Col. 6, lines 21-52.)

Various commercial computer-implemented systems and methods for managing child support payments exist. Typical systems are designed for divorced couples and merely facilitate tracking of child support payments after a divorce agreement and/or child support order has been entered. The following are some examples of such web-based co-parenting apps (and a person of ordinary skill in the art would be aware of other examples): (1) Onward (https://www.onwardapp.com/), a platform for both parents to manage and split co-parenting expenses; (2) CustodyXChange (https://www.custodyxchange.com/), a platform for creating and managing a co-parenting plan; and (3) SupportPay (https://supportpay.com/), which is essentially an expense report for child support payments and expenses. Such tracking of child support typically involves only manually uploading receipts and generating related reports. Another example is (4) DComply (https://www.dcomply.com/), which is configured so that only the receiver of child support—presumably the custodial parent—can set up the account. The DComply app, like the others, requires a divorce agreement specifying a child support obligation. With the DComply app, the account holder receives child support payments electronically via ACH deposit (requiring the account holder to share their checking account information with the app) from the other parent. The DComply app includes a tracking expense feature to assist the account holder when seeking reimbursement from the other parent for out-of-pocket expenses.

First deficiency in the art. The above-identified art is not configured to manage pre-legal child support payments by putative fathers. Rather, as mentioned above, they are configured to facilitate payments and/or tracking of payment and expenses for divorced couples who have a divorce settlement and/or child support order. Putative fathers need evidence of pre-legal child support payments—i.e., not only that payments were made, but that they are not to be considered as “gifts.” The foregoing evidence is helpful when presented to a family court to ensure that the putative father does not need to make arrears for (potentially) alleged non-payment during the period after birth of the child until the present legal hearing.

Second deficiency in the art. The above-identified art is not configured to track and record pre-legal involvement of the putative father with the child. Aside from child support payments, putative fathers need (or greatly benefit from) evidence of such pre-legal involvement including: (1) Evidence of active participation with the child, such as overnight visitations and time spent during non-overnight situations (e.g., attending school plays or other functions); (2) Evidence of involvement in (joint) decision-making about the child; and (3) Evidence of one or more pre-legal agreements, especially in writing, between the putative father and the mother as to some or all of the foregoing items (1) to (2). The foregoing evidence is helpful when presented to a family court judge to ensure the father is given his fair share of rights with the child.

Third deficiency in the art. The above-identified art is not configured to prevent the mother from misusing child support payments made by the putative father. Additionally, the father will have little or no way of determining whether such misuse has occurred if the mother doesn't disclose how she is using the child support funds. The above-identified commercial systems provide only as much transparency as each parent records their spendings with the app. If such misuse is uncovered, the father may be inclined to purchase goods or services himself for the child, whereby the purchase cost may be applied against his child support obligation (although he may later need to prove this). The above-identified Patent Document 3 provides for a father to make a purchase for the child at the behest of the mother, including whether to approve or decline the purchase, thereby limiting or preventing such “misuse.” However, its application is limited to where a child support obligation is registered with a government agency, the parents wish to make the purchase online (which is then shipped to the custodial parent) from a merchant that is registered with the direct support (DS) system of Patent Document 3, and the custodial parent initiates the selection of goods or services. Thus, Patent Document 3 does not address the aforementioned problem as it pertains to a putative father.

Fourth deficiency in the art. Another deficiency relating to Patent Document 3 includes, but is not limited to, the following: (1) the father must be reachable in order to complete the online purchase, (2) it would be burdensome for the father to need to approve every single purchase made by the mother on behalf of their child, and (3) the mother would inevitably feel frustrated always having to wait for the father's approval and her inability to make purchases for their child on her own with the child support funds that are legally given to her. If there is a delay, such as the father not being reachable, as above, the child's needs may not be met in a timely manner.

Fifth deficiency in the art. The above-identified art is not configured to credit the putative father with such expenses as housing, car rentals, etc.

Sixth deficiency in the art. The above-identified art does not store records of child support payments and expenses in a way that is impervious or near impervious to cyber-attacks/hacking.

There is a need to address the prior art's inability to distinguish pre-legal child support payments and contributions apart from gifting. There is also a need for a putative father to thoroughly document his level of involvement with the child, both financially and socially, to build the strongest possible case before family court, as it will influence a family court's decision when determining the father's level of custody, visitation, child support obligation and decision making. The documentation should preferably be in in the form of incontrovertible evidence to disprove fraudulent evidence submitted by the mother to family court, if necessary.

### SUMMARY OF THE INVENTION

The present invention provides a pre-legal child support management system and method of using the same, which addresses or solves the aforementioned problems or deficiencies in the art. Implementations of the present invention includes one or more of the following.

There is provided, in accordance with one embodiment of the present invention, a system for managing prelegal child support payments. The system comprises at least one processor configured to communicate with at least one computing device over a communication network, and a memory, in which the memory stores instructions. The instructions, when executed by the at least one processor, direct the at least one processor to issue a debit card to a custodial parent having a custodial parent user account. The custodial parent debit card is linked to a system bank account associated with, and managed from, a non-custodial parent user account.

In one embodiment, the memory further stores a modifiable list comprising at least one of restricted merchants, merchant types, and dates and times of purchase. The instructions further direct the at least one processor to prevent completion of purchases with the custodial parent debit card according to restrictions set forth in the modifiable list. The non-custodial parent user account has access to modify the modifiable list.

In one embodiment, the memory further stores a list of registered merchants. The instructions direct the at least one processor to monitor purchases made with the custodial parent debit card at each of the registered merchants and create a spending baseline associated with each of the registered merchants over a predetermined amount of time. The instructions further direct the at least one processor to compare future purchases made with the custodial parent debit card at each of the registered merchants after the predetermined amount of time, and send an alert to the non-custodial parent user account when a purchase falls outside the spending baseline.

In one embodiment, the system further comprises a blockchain. The system bank account is funded with system-issued crypto tokens.

In one embodiment, the custodial parent debit card has a monthly spending limit. The instructions direct the at least one processor to send a request for additional funds to the non-custodial parent user account when usage of the custodial parent debit card exceeds the monthly spending limit.

In one embodiment, the instructions further direct the at least one processor to store, on a database in the memory, an amount of child support to be provided by the non-custodial parent for a child. The instructions further direct the at least one processor to calculates a child support balance after deducting each purchase made with the custodial parent debit card, and report the child support balance to the non-custodial parent user account and the custodial parent user account at predetermined intervals.

There is provided, in accordance with one embodiment of the present invention, a system for managing prelegal child support payments. The system comprises at least one processor configured to communicate with at least one computing device over a communication network, and a memory, in which the memory stores instructions. The instructions, when executed by the at least one processor, directs the at least one processor to issue a debit card to a non-custodial parent having a non-custodial parent user account. The non-custodial parent debit card is linked to a system bank account associated with, and managed from, the non-custodial parent user account.

In one embodiment, the instructions further direct the at least one processor to store, on a database in the memory, an amount of child support to be provided by the non-custodial parent to a custodial parent having a custodial parent user account, and a visitation schedule for the non-custodial parent. The visitation schedule comprises overnight visitation dates and non-overnight visitation dates. The instructions further direct the at least one processor to create a shared calendar having the visitation schedule and link the shared calendar with the non-custodial parent user account and the custodial parent user account. The instructions further direct the at least one processor to designate purchases made with the non-custodial parent debit card on the overnight visitation dates as child support expenses and send an approval or denial request to the custodial parent user account for purchases made with the non-custodial parent debit card on the non-overnight visitation dates. The approved non-overnight visitation date purchases are designated as child support expenses and the denied non-overnight visitation date purchases are designated as non-child support expenses. The instructions further direct the at least one processor to calculate a child support balance after deducting the child support expenses and update the shared calendar to list each purchase and store the child support balance. The shared calendar reports the child support balance to the non-custodial parent user account and the custodial parent user account at predetermined intervals.

In one embodiment, the memory further stores a modifiable list comprising at least one of permitted merchants, merchant types, and dates and times of purchase. The instructions direct the at least one processor to complete purchases with the non-custodial debit card on the non-overnight visitation dates according to permissions set forth in the modifiable list. The custodial parent user account has access to modify the modifiable list.

In one embodiment, the instructions further direct the at least one processor to issue a debit card to the custodial parent. The custodial parent debit card is linked to the system bank account. The instructions further direct the at least one processor to designate purchases made with the custodial parent debit card as child support expenses and calculate the child support balance after deducting the child support expenses.

In one embodiment, the memory further stores a modifiable list comprising at least one of restricted merchants, merchant types, and dates and times of purchase. The instructions direct the at least one processor to prevent completion of purchases with the custodial parent debit card according to restrictions set forth in the modifiable list. The non-custodial parent user account has access to modify the modifiable list.

In one embodiment, the memory further stores a list of registered merchants. The instructions direct the at least one processor to monitor purchases made with the custodial parent debit card at each of the registered merchants and create a spending baseline associated with each of the registered merchants over a predetermined amount of time. The instructions further direct the at least one processor to compare future purchases made with the custodial parent debit card at each of the registered merchants and send an alert to the non-custodial parent user account when a purchase falls outside the spending baseline.

In one embodiment, the system further comprises a blockchain. The system bank account is funded with system-issued crypto tokens.

In one embodiment, the instructions further direct the at least one processor to store, on the database, a separate amount of child support and a separate visitation schedule for each one of two or more children of the non-custodial parent. The instructions further direct the at least one processor to create a sub-account in the system bank account for each one of the two or more children, and assign each of the child support expenses to the relevant sub-account.

In one embodiment, the instructions further direct the at least one processor to store, on the database, a separate amount of child support and a separate visitation schedule for each one of two or more children of the non-custodial parent of which the custodial parent is a co-parent. The instructions further direct the at least one processor to create a sub-account in the system bank account for each one of the two or more children, and assign each of the child support expenses to the relevant sub-account.

There is provided, in accordance with one embodiment of the present invention, a method for managing prelegal child support payments. The method comprises controlling, by at least one processor of a server configured to communicate with at least one computing device over a communication network, the step of issuing a debit card to a custodial parent having a custodial parent user account. The custodial parent debit card is linked to a system bank account associated with, and managed from, a non-custodial parent user account.

In one embodiment, the method further comprises, controlling, by the at least one processor, the step of issuing a debit card to a non-custodial parent having a non-custodial parent user account. The non-custodial parent debit card is linked to a system bank account associated with, and managed from, the non-custodial parent user account.

In one embodiment, the method further comprises controlling, by the at least one processor, the steps of storing, on a database in a memory, an amount of child support to be provided by the non-custodial parent to the custodial parent having a custodial parent user account, and a visitation schedule for the non-custodial parent. The visitation schedule comprises overnight visitation dates and non-overnight visitation dates. The method further comprises controlling, by the at least one processor, the steps of creating a shared calendar having the visitation schedule and linking the shared calendar with the non-custodial parent user account and the custodial parent user account. The method further comprises controlling, by the at least one processor, designating purchases made with the non-custodial parent debit card on the overnight visitation dates and purchases made with the custodial parent debit card as child support expenses and sending an approval or denial request to the custodial parent user account for purchases made with the non-custodial parent debit card on the non-overnight visitation dates. The approved non-overnight visitation date purchases are designated as child support expenses and the denied non-overnight visitation date purchases are designated as non-child support expenses. The method further comprises controlling, by the at least one processor, the steps of calculating a child support balance after deducting the child support expenses, and updating the shared calendar to list each purchase and store the child support balance. The shared calendar reports the child support balance to the non-custodial parent user account and the custodial parent user account at predetermined intervals.

In one embodiment, the method further comprises controlling, by the at least one processor, the steps of storing, on the memory, a modifiable list comprising at least one of restricted merchants, merchant types, and dates and times of purchase, and preventing completion of purchases with the custodial parent debit card according to restrictions set forth in the modifiable list. The non-custodial parent user account has access to modify the modifiable list.

In one embodiment, the method further comprises: controlling, by the at least one processor, the step of storing, on the memory, a list of registered merchants. The method further comprises controlling, by the at least one processor, the step of monitoring purchases made with the custodial parent debit card at each of the registered merchants and creating a spending baseline associated with each of the registered merchants over a predetermined amount of time. The method further comprises controlling, by the at least one processor, the step of comparing future purchases made with the custodial parent debit card at each of the registered merchants after the predetermined amount of time and sending an alert to the non-custodial parent user account when a purchase falls outside the spending baseline.

### BRIEF DESCRIPTION OF THE DRAWINGS

The accompanying figures illustrate several embodiments of the invention and, together with the description, serve to explain the principles of the invention. One of ordinary skill in the art readily recognizes that the particular embodiments illustrated in the figures are merely exemplary and are not intended to limit the scope of the present invention.

FIG. 1 illustrates a system and method for facilitating pre-legal child support management in accordance with an embodiment.

FIG. 2 illustrates a system and method for setting up accounts in the pre-legal child support management system in accordance with an embodiment.

FIG. 3 illustrates a system and method for managing reoccurring expenses in accordance with an embodiment.

FIG. 4 illustrates a system and method for managing additional expenses in accordance with an embodiment.

FIG. 5 illustrates a system and method for paying expenses in accordance with an embodiment.

### DETAILED DESCRIPTION OF THE PREFERRED EMBODIMENT

Reference will be made in detail to the embodiments of the disclosure, examples of which are illustrated in the accompanying drawings.

### Definitions and Explanation of Terms

The following is a list of definitions and explanation of terms and words used herein.

As used herein, the term “additional expenses,” which is interchangeably used with “incremental expenses,” refers to expenses that the mother of a child and putative father incur prior to life or over the life of the child. The additional expenses will be based upon estimated future necessities, along with various activities, the child's age that includes, but are not limited to, any of clothing costs, shelter costs, medical bills and health care, education fees, daycare fees, and extracurricular activities of the child until a legal parental interest is established that includes a court ordered parenting plan.

As used herein, the term “blockchain,” which is the technology behind digital assets, is a peer-to-peer decentralized distributed ledger that makes the records of any digital asset transparent and unchangeable, working without involving any third-party intermediary. This definition is not intended to depart from the term's ordinary meaning in the art.

As used herein, the term “coin” refers to digital money such as bitcoin or dogecoin has the same features as money wherein individual coin ownership records are stored in a ledger existing in a form of a computerized database.

As used herein, the term “cryptocurrencies” refers to digital assets designed to work as a method of exchange (trade). Like any currency, crypto's gain their value based on the scale of community involvement (like the user demand, scarcity, or coin's utility).

As used herein, the term “DocuDad,” interchangeably used with “DocuDad network,” “DocuDad platform” and “DocuDad system,” refers to the network in which the pre-legal child support management system of the present invention operates.

As used herein, the term “DocuDad Token (DDT)” (interchangeably used with “DD token” or “DDT”) refers to an Ethereum-powered token for the DocuDad platform of the present invention. The platform aims to make child support borderless while preparing its users for the unique dynamics of parenting.

As used herein, the term “denial letter” (see step 324, for instance) refers to a system-issued letter sent to the putative father after the mother of the child refuses a child support acceptance request (see steps 322 or 348). The term “denial notification” as used herein has a similar meaning, in which the mother of the child denies (i.e., withholds approval for) an attempted purchase by the putative father using with the primary debit card on a date when the father does not have overnight visitation (see step 424).

As used herein, the term “Ethereum” refers to a decentralized, open-source blockchain with smart contract functionality. Ether is the native cryptocurrency of the DocuDad platform. These definitions are not intended to depart from these term's ordinary meaning in the art. However, the DocuDad platform may be adapted to utilize other known forms of blockchain and cryptocurrency and/or crypto tokens, as would be readily apparent to a person of ordinary skill in the art.

As used herein, the term “financial support contract” refers to system contract, executed by the putative father, which states the financial terms of pre-legal child support (see step 236). The financial support contract comprises an agreed upon monthly monetary amount of child support that is to be paid from a putative father to the mother of child, and the various methods that can be used to reach the sum of the agreed monthly amount. Any form of financials contributions beyond the agreed upon amount will still be considered as child support. The purpose of the financial support contract is to ensure all forms financial contributions from a putative father are documented and accredited with the intended purpose of child support (and not as a gift) by a court in the future. The financial support contract is sent or linked to a created shared calendar (via step 238). Entering an agreed upon monetary amount in the financial support contract for debit card usage will trigger the system to automatically enter a monthly limit on the primary and secondary debit cards. Each time an expense is completed with either card, the total will be subtracted from the foregoing agreed upon monetary amount. Likewise, when other forms of child support are entered into the system, such as providing housing, car rentals, etc., the total will be subtracted from the foregoing agreed upon monetary amount.

As used herein, the term “internal bank account” refers to a bank account of an internal banking system of (i.e., which is internal to) the DocuDad Network (i.e., “the system”). The internal bank account is associated with a primary user or primary account holder (i.e., the putative father). The primary and secondary debit cards are issued from the internal bank account. The internal bank account is funded by the primary account holder. The account is funded in any conventional manner, including, but not limited to depositing money, depositing checks, electronic transfer, wire transfer, cryptocurrency or crypto tokens. In one embodiment, the funds are in the form of DD Tokens (as defined above). The internal banking system will keep records of all expenses paid by either card. Each debit card has a unique card identifier and/or number. The internal banking account is in communication with the shared calendar. For example, expenses purchased using the secondary debit card are automatically associated with non-overnight visitation dates. The internal banking system is also configured to automatically synchronize/transfer all “pre-approved expenses” (as defined below) incurred by either debit card over to the shared calendar except for contested expenses incurred on non-overnight visitations made with the primary debit card. Contested expenses can be challenged with a resolved or unresolved conclusion. Either resolution may be printed out and manually entered into the prelegal child support management system with supporting documentation.

As used herein, the term “non-custodial parent” refers to a parent who does not have primary physical custody of his or her children. This is typically the putative father (defined below).

As used herein, the term “overnight visitation” (interchangeably used with “overnight visitation date(s)”) refer to the dates upon which the putative father has an overnight visitation according to the parental commitment contract (defined below) and reflected in the shared calendar. Similarly, the term “non-overnight visitation” (interchangeably used with “non-overnight visitation date(s)”) refer to the dates upon which the putative father does not have an overnight visitation according to the parental commitment contract (defined below) and reflected in the shared calendar. Since the custodial parent is typically the mother, when referring to the custodial parent's schedule to have the child, the above terms will be used to refer to the days when the mother is scheduled to have the child (i.e., non-overnight visitation date[s]) and when the mother is not scheduled to have the child (i.e., overnight visitation date[s]).

As used herein, the term “parental commitment contract” refers to documents for coparents to sign, giving the opportunity to acknowledge and accept the efforts of the other parent (i.e., a temporary parenting plan). The term “parental commitment contract” is used interchangeably with such terms as “parental commitment letter,” “commitment to parental obligations” (CPO), and “parental parenting pact.” Each party commits to fulfilling certain obligations pertaining to a child while accepting the other party's role to unify the family by means of a co-parenting partnership for the best interest of the child. These commitment contracts offer structure and guidance to coparents, including, but not limited to, a visitation schedule. In the case of a “parental commitment contract,” the father acknowledges that he is the biological father of the child (although it is still a temporary agreement/contract). In the case of a “temporary parental commitment contract,” the father expresses unsureness of his biological relations to the child.

As used herein, the term “pre-approved purchase,” interchangeably used with “pre-approved expense,” refers to any one of the following three situations:
a. a purchase made (by the non-custodial parent) with the primary debit card on an overnight visitation date;
b. a purchase made (by the custodial parent) with the secondary debit card on any date (i.e., on both overnight and non-overnight visitation dates for the father); or
c. a purchase made (by the non-custodial parent) with the primary debit card on a non-overnight visitation date, whereby the system sends a request to the custodial parent to approve or deny the purchase, and the custodial parent approves the purchase.

As used herein, the term “pre-legal child support management system,” which is interchangeably used with “the system,” refers to the system of the present invention, which is configured for a putative father to make child support payments and/or cover expenses, either by directly making purchases himself or by providing the means through which the mother of the child can do so, as well as document his participation in the child's life, prior to receiving a child support order in family court.

As used herein, the term “primary database” refers to a central database of the system, in which all executed agreements/contracts (that is, executed by both the putative father and the mother) are stored and retrievable/viewable by both the putative father, the mother and, where applicable, to an attorney who is granted limited access by the father, as described below. All communications/messages between the putative father and mother via one or more internal communications platforms of the system, will also be viewable from the primary database. (Likewise, such communications/messages will be viewable to both parties via the shared calendar.) All other documents that are created or imported from an external source, to the primary database, will only be accessible by the uploading party unless they choose to upload the document in a shared spaced within the primary database (or in a shared space within the shared calendar).

As used herein, the term “primary debit card,” which is interchangeably used with “non-custodial parent debit card,” refers to the debit card that is issued through the system to the non-custodial parent (i.e., putative father) for pre-approved child support expenses. The primary debit card is linked to the internal bank account (of the system) funded by the primary account user (i.e., the putative father).

As used herein, the term “putative father,” which is interchangeably used with “non-custodial parent,” refers to a man who has no legally established relationship to a child because he is not married to the child's mother—but who either claims to be the biological father of the child, or who is alleged to be the biological father of the child as claimed by the mother.

As used herein, the term “reoccurring expense” refers to any estimated monthly expense amount using a child support calculator, an amount agreed upon by the mother of a child and putative father, or an amount offered by a putative father. The estimated monthly expense amount is based on the anticipated purchase of, or payment for, “reoccurring” goods and services.

As used herein, the term “secondary debit card,” which is interchangeably used with “custodial parent debit card,” refers to an authorized debit card that is issued through the platform to the custodial parent (i.e., mother of a child; aka the “authorized user”; aka the “secondary user”) for pre-approved child support expenses. The secondary debit card is linked to the internal bank account (of the system) funded by the primary account user (i.e., the putative father). Note: All transactions made using the secondary debit card are “pre-approved” (as defined above) and will be completed. However, the putative father can make notations of contested transactions he may feel are unrelated to child support for future use as evidence in the event the mother of a child incurs personal expenses such as personal manicure, pedicure, hair salon, jewelry, etc., to present in or out of family court when arguing the best interest of a child when pursuing increased overnight visitations or other rights.

As used herein, the term “shared calendar” (i.e., “secondary” database) refers to a dedicated space or database (separate from the primary database, defined above) for a mother of a child and putative father to schedule, view, update, and modify arrangements pertaining to a child's routine. This “secondary” database keeps record of each party's level of involvement with the child and details the specifics of non-overnight visitation participation such as school drop-offs and/or pick-ups.

As used herein, the term “utility token” refers to a digital asset, having a wider functionality than a coin. Utility tokens do have value, but cannot be considered as actual money compared to a coin. They can provide value in different ways, such as giving users access to a future product or service.

As will be discussed below in further detail, in accordance with one embodiment of the present invention, a computer-implemented pre-legal child support management system and method is provided that comprises agreements forms and contracts that are temporary, pending paternity results or the legal establishing of a father's parental interest. The temporary agreements and contracts set forth the agreed upon visitation schedule and an amount of child support to be paid by the putative father. (A person having ordinary skill in the art would readily recognize that the DocuDad system may be configured according to any known method in the art for entering a visitation schedule and amount of child support to be provided—i.e., without requiring the aforementioned agreements and contracts.) In one embodiment, the system further comprises a shared calendar, which divides overnight visitations from non-overnight timesharing a putative father spends with a child according to the temporary agreements and contracts described herein. The shared calendar is linked to a banking system that issues debit cards with the putative father being the primary account holder (and thus financially responsible), providing a secondary debit card issued through the platform to the mother of a child (i.e., authorized/secondary user) for pre-approved child support expenses. Each overnight visitation transaction made with either card is automatically approved. Each non-overnight visitation transaction made with either card sends a notification to the other party to verify the purpose of the expense. The system records transactions into the banking system as either a child support expense or a regular banking expense (i.e., a non-child support expense). Total monthly child support expenses made by both card holders using the present art's banking system automatically is communicated to the shared calendar. In one embodiment, the DocuDad Token (DDT) is the universal medium of exchange for the DocuDad network—i.e., the network in which the pre-legal child support management system operates—and is used to load each debit card for child support purposes. Records generated and/or stored in the system can be used as legal documents once either a putative father registers with a putative father registry in his State or if any family legal proceeding commences with an assigned case number.

In one embodiment, in addition to payment via DD tokens as described above, the present invention also records child support payments, and expenses covered, by other methods such as, but not limited to, cash, check, money order, cash app, bank transfer, equitable (e.g., car loan, housing) and other methods known in the art. When such “other methods” are used, the system generates and sends a notification to the mother of the child to confirm that such “other method” was used and the amount that was given. The system records the transaction into the banking system as either a child support expense (if approved by the mother) or a regular/non-child support banking expense (if denied by the mother). In one embodiment, where a blockchain is used, the system also records the transaction(s) on the blockchain.

In one embodiment, system activity, including, but not limited to, payment transactions, communications between the non-custodial parent and the custodial parent via a system communication and messaging platform, system-generated documents/files, uploaded documents/files (that is, documents/files uploaded to the system), etc., are recorded on the blockchain. This creates an immutable (or near-immutable) record of evidence of parental support and involvement by the non-custodial parent for the purpose of submitting such evidence to family court for a child support and custody hearing, for instance.

The following description is presented to enable one of ordinary skill in the art to make and use the invention and is provided in the context of a patent application and its requirements. Various modifications to the described embodiments and the generic principles and features described herein will be readily apparent to those skilled in the art. Thus, the present invention is not intended to be limited to the embodiments shown, but is to be accorded the widest scope consistent with the principles and features described herein.

A system and method in accordance with the present invention provides an effective, non-disruptive system (e.g., website, web application, or mobile application, banking system, and cryptocurrency token) to facilitate communication and pre-legal child support related expenses and payments between the mother of the child and putative father. By providing a pre-legal child support management system, that includes a central repository to store joint documents, between two parties, managing expenses incurred by at least one of the two parties, and calculating an amount of pre-legal child support paid by the putative father, the amount of pre-legal child support paid is communicated by the pre-legal child support management system to each of the two parties to enable the streamlined payment of pre-legal child support expenses.

To describe the features of the present invention in more detail, refer now to the following description in conjunction with the accompanying Figures.

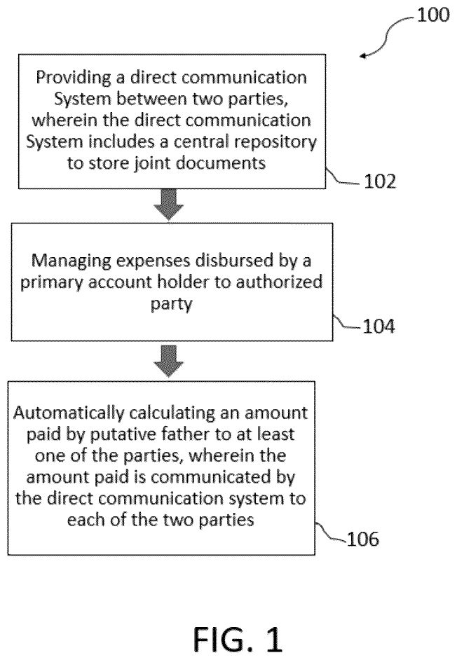

FIG. 1 illustrates a method 100 for facilitating pre-legal child support management in accordance with an embodiment. The method 100 comprises providing a pre-legal child support management system to enable direct communication of terms and methods of pre-legal child support that will be offered and accepted between two parties, wherein the pre-legal child support management system includes a central repository to store joint documents, via step 102. In one embodiment, the pre-legal child support management system is any of a web, app, mobile, and tablet based social networking platform that is capable of managing multiple children and multiple pre-legal child support cases at once as well as facilitating pre-legal child support payments between the mother of a child and the putative father. In another embodiment, the pre-legal child support management system facilitates the exchange of information between every unique State and Putative Fathers Registry.

The method 100 includes managing the terms and expenses paid by a putative father, via step 104, and automatically calculating an amount paid by a putative father, wherein the amount paid is communicated by the pre-legal child support management system to each of the two parties, via step 106. In one embodiment, the expenses are entered into the pre-legal child support management system by way of at least one parent making purchases, payments or incurring expenses via internal banking system or automatic entering of the expense based upon equitable value such as housing costs. In one embodiment, information in the central repository is leveraged and shared by the pre-legal child support management system to automatically calculate monthly pre-legal child support payments paid by a putative father.

In one embodiment, the two parties are the mother of a child and a putative father whose support payments are at issue and the joint documents stored by the central repository include, but are not limited to, physical and electronic copies of receipts, invoices, DD token transfers, banking statements, settlements, and child related information such as medical records, report cards, awards, and pictures. The messaging communications between the mother and a putative father are tracked by the pre-legal child support management system.

In one embodiment, the managing step 104 of the method 100 further comprises tracking both reoccurring and additional expenses incurred by each of the two parties in a banking system with the primary account holder (i.e., the putative father) assuming financial responsibility. The reoccurring expenses include, but are not limited to, any estimated monthly expense amount using a child support calculator, an amount agreed upon by the mother of a child and putative father, or an amount offered by a putative father. The additional expenses are incremental expenses that the mother of a child and putative father incur prior to life or over the life of the child. The additional expenses will be based upon estimated future necessities, along with various activities, the child's age that includes, but are not limited to, any of clothing costs, shelter costs, medical bills and health care, education fees, daycare fees, and extracurricular activities of the child until a legal parental interest is established that includes a court ordered parenting plan.

In one embodiment, the method 100 further includes facilitating payments made by at least one of the two parties to the other one of the two parties, facilitating payments made by at least one of the two parties directly to a third party, wherein the other one of the two parties is notified of the payments made directly to the third party, and automatically calculating the amount paid and or balance remaining by at least one of the two parties to ensure that agreed payment obligations are met by putative father. Accordingly, the pre-legal child support management system tracks, records, and facilitates payments that occur directly between the mother of a child and putative father, and tracks, records, and facilitates payments that occur directly between either the mother of a child or putative father and a third party.

In one example, if the child of a mother and putative father has incurred an additional incremental expense including, but not limited to, a daycare cost, the pre-legal child support management system enables either party to directly pay the third-party daycare facility for the daycare cost incurred by the child thereby bypassing the putative father paying the mother. In this example, the payee is the third party directly and so both parties will receive a notification of the daycare cost payment from the pre-legal child support management system.

In one embodiment, if payment funds by putative father are inadequate, missing, or late, the remaining amount will be automatically calculated and communicated to each party. In one embodiment, the pre-legal child support management system determines any past due expenses past a predetermined time period including, but not limited to, 30 days. In this embodiment, the pre-legal child support management system calculates a new balance reflecting remaining balance of the previous time period until balance is paid in full.

In one embodiment, an additional payment amount is calculated by adding the principal amount of the monthly pre-legal child support to the unique previous balance over a past due time period. The pre-legal child support management system updates the amount due and sends a notification message to both the mother of a child and putative father notifying them of the past due amount and new total amount due.

In one embodiment, where the totality of purchases made with the secondary debit card exceeds the monthly spending limit, the system notifies the non-custodial parent who may choose whether to approve and load additional funds (if needed) to the secondary debit card (via the bank account). The system records a credit to the non-custodial parent for having paid more than the agreed-upon monthly amount. In another embodiment, the system allows the mother to preemptively request such additional funds before the totality of purchases made with the secondary debit card exceeds the monthly spending limit.

In one embodiment, the method 100 further includes tracking communications by each of the two parties to the pre-legal child support management system and notifying at least one of the two parties regarding the communications to ensure each of the two parties is actively involved. The communications include but are not limited to status updates and updates on child events.

One of ordinary skill in the present art readily recognizes that the pre-legal child support management system can include a variety of features including, but not limited to, a mobile application, an external website with a home page and login module, a support management main site with a dashboard, payment reports, payments module, all reports module, expenses module, document images, all documents module, receipt images, account management module, SMS messages, shared calendar (view, edit, or delegate permission). DocuDad cryptocurrency tokens, primary (primary user) debit card, secondary (authorized user) debit card, payor (party making payments), payee (party receiving payments), children, mother and putative father information modules, pre-legal support agreement details, and merchant details; a registration wizard with a checklist, the mother of a child and putative father sign up modules, payment method setup. Systems to communicate with one another, syncing information from one platform to the next. System components and function of invention—Processor, memory device, and central repository.

In one embodiment, the DocuDad system issues a debit card only to the custodial parent (i.e., the mother). The purpose of this embodiment is to provide the putative father with a record of pre-legal child support payments, in addition to other beneficial features described herein, such as monitoring and controls over how the child support funds are utilized. In another embodiment, the DocuDad system only issues a debit card to the non-custodial parent. This embodiment also provides the putative father with a record of pre-legal child support payments, in addition to other beneficial features described herein, such as a record of parental involvement, which is linked to the shared calendar (defined above). In yet another embodiment, the DocuDad system issues a primary debit card to the putative father (or non-custodial parent) and a secondary debit card to the mother (or custodial parent) as described herein. The aforementioned debit card(s) may be funded in any conventional manner. As described above, in one embodiment, the debit card(s) is funded with DD tokens (defined above).

In one embodiment, a “internal” payment gateway is provided, which is internal to the DocuDad system (i.e., it is not a third-party payment gateway). The internal payment gateway is configured to filter/screen purchases made with the secondary debit card against possible misuse of child support funds by the mother/custodial parent. In this embodiment, merchants must register with the DocuDad Network (i.e., “the system”) in order to accept payment via the primary and secondary debit cards. The merchants, when registering with the system, provide identifying information about their business (e.g., business name, address, etc.) and select a “merchant type” (interchangeably used with “merchant category”) from among a predefined list of merchant types preprogrammed into the system. (The list of merchant types can be expanded to include additional merchant types.) A primary user optionally sets restrictions at the internal payment gateway level. In one embodiment, such restrictions include a Whitelist and/or a Blacklist. Whitelisting and Blacklisting are two methodologies to control access to websites, email, software and IP addresses on networks. Whitelisting denies access to all resources except those excluded or granted access by the account administrator. Blacklisting allows access to all with the provision that only certain items (e.g., merchants, websites, etc.) are denied. Accordingly, a primary user may block access to specific businesses—i.e., prevent payment to those businesses with the secondary debit card—either by adding those specific businesses to a Blacklist, by adding the merchant type covering that business to the Blacklist, or by using a Whitelist and not adding the specific business or its merchant type to the allowed list.

In one embodiment, the internal payment gateway includes spending limit controls. For example, the primary user may set a monthly spending limit on the secondary debit card with respect to a specific business, a group of enumerated businesses, or for an entire business type. This restriction provides the putative father with some budgetary control over the nature and cost of specific types of goods or services purchased for the child using child support funds. For example, the father may not agree to purchasing high-end goods for the child. By setting a limit at certain merchants, the mother may be disinclined to overspend on specific goods or services for the child, at the risk of having insufficient funds for other necessary child-related expenses at those same merchants, despite having additional child support funds available overall.

In one embodiment, when the mother wishes to use the secondary debit card with a registered merchant, the mother must create a new account with the merchant via the DocuDad system. The account setup via the DocuDad system requires the mother to identify a putative father who is registered with the DocuDad system. The DocuDad system provides the identified putative father with limited access to the newly created account with the merchant. Such limited access is necessary for the putative father to be able to retrieve and view the merchant identification (and associated information) and an itemized lists of previously purchased goods or services to determine if there has been misuse of child support funds by the mother.

In one embodiment, the mother has limited access to the account with which the father attempts to make a purchase using the primary debit card on a non-overnight visitation date. The limited access includes, but is not limited to, retrieving and viewing the merchant identification (and associated information) and an itemized lists of goods or services that the putative father wishes to purchase, but for which the putative father requires the mother's approval (as described above). In one embodiment, when the system sends a request to the mother to approve (or deny) such purchase request by the putative father, the request includes a link to retrieve and view an itemized lists of the goods or services to be purchased.

In one embodiment, the internal payment gateway is configured to restrict based upon date and time. In this embodiment, the internal payment gateway is optionally set to restrict or allow certain approved merchants and/or merchant type(s) on certain days and at certain times. For example, on overnight visitation dates—i.e., when the mother does not have the child—the internal payment gateway may be set up to restrict the mother from using the secondary debit card at a sit-down restaurant.

In one embodiment, the custodial parent has limited access to the internal payment gateway in order to provide pre-approval to the non-custodial parent to make purchases with the primary debit card at specific merchants and/or one or more merchant types on non-overnight visitation dates. Such pre-approval then allows the father to make purchases for the child even on non-overnight visitation dates without having to request (and wait for) approval from the mother.

In one embodiment, a monitoring and alert generating module is provided (hereinafter, the “monitoring module”). The monitoring module tracks spending frequency and value (e.g., dollar amount) at each merchant/vendor, determines a baseline of spending habits, and generates an alert that is sent to the primary user when a purchase falls outside the foregoing baseline. The purpose of this module is to protect against possible misuse of child support funds by the mother/custodial parent. For example, the mother shops (for the child) at a particular vendor once a month spends around $200 each time over a period of three or fourth months, thereby creating a baseline (although the baseline can be configured based on any arbitrary frequency or other criteria known in the art). The monitoring module will then compare future purchases against the foregoing baseline. Subsequently, if the mother spends $400 one month at that same vendor (or any other amount that drastically differs from the established baseline), the monitoring module will issue an alert to the putative father at a registered device of his choosing. In one embodiment, the alert optionally includes a link to the specific purchase order about which the alert was generated, thereby providing an itemized list of the purchased items for review by the putative father.

In one embodiment, the DocuDad system is configured to communicate with one or more cryptocurrency payment gateways, which are external to the DocuDad system. A cryptocurrency payment gateway is a payment processor for digital currencies, which enable merchants (and others) to accept digital payments and receive fiat currency immediately in exchange. In this embodiment, merchants need not be registered with the DocuDad system (although they may optionally do so) in order to receive payment via the DocuDad system in the form of DD tokens for purchases made with either one of the primary or secondary debit cards. The merchant converts the DD Tokens to fiat currency via one of the external cryptocurrency payment gateways.

In one embodiment, the DocuDad system is configured with an internal cryptocurrency payment gateway, by which means a merchant chooses whether to receive payment in the form of fiat currency or in DD Tokens. In another embodiment, the merchant only receives payment in the form of fiat currency.

In one embodiment, the merchant stores the received DD tokens in an external cryptocurrency wallet. In another embodiment, merchant stores the received DD tokens in an internal cryptocurrency wallet (i.e., that is, a “wallet” internal to the DocuDad system). In another embodiment, the merchant optionally stores the received DD tokens in either one or an “external” or “internal” cryptocurrency wallet. The “external” cryptocurrency wallet may be of any type known in the art. The “internal” cryptocurrency wallet may be configured according to any known type in the art.

In all of the foregoing external and internal cryptocurrency payment gateway embodiments, the DocuDad system provides a benefit to the putative father in that the father retains certain controls over the child support funds after the funds are made available to the mother via funding of the secondary debit card. Some of the controls have been described above (e.g., the internal payment gateway filter/screen), while other controls will be described below.

In one embodiment, the dashboard of the pre-legal support management main site includes a to-do list module, a quick links module, and expenses organized by time module, an expenses-organized-by-category module, and a history module showing account changes over a predetermined time period including but not limited to 60 days. The do list module includes the ability to complete parenting (fathering) educational courses, reply to disputes, sign agreements, sign contracts, review documents and receipts, and pay current expenses and expenses that are past due.

In one embodiment, the quick links module includes the ability to pay expenses, add/edit expenses, add/edit payees, add/edit merchants, add/edit documents, add/edit reports, and send messages to other parties or users of the pre-legal child support management system. The history module organizes payments into sections comprising past due payment amounts, pending payments amounts, and historical payments amounts. Items listed under the past due payments section can either be paid or disputed. Items listed under the historical payments section are sortable by various dropdowns including but not limited to status, dates, payee name and type, and category.

When viewing the reports module of the dashboard, a variety of reports are creatable including, but not limited to, custom reports and standard reports. In one embodiment, custom reports are sortable by various dropdowns including, but not limited to, status, dates, payee name, type, and category. Standard reports include, but are not limited to, payments made and payments received each in year to date, last twelve months, and previous tax year views, and total expenses in category, and payee views. These reports can be leveraged by either party and can also serve as certified third-party proof for an external third party including, but not limited to, the IRS or judicial entities. The reports are generated from data stored in either one, or both of, the primary database and the shared calendar.

When viewing the expenses module, both reoccurring and additional expenses are displayed and sortable by various dropdowns including, but not limited to, status, dates, payee name and type, and category. A variety of actions can be applied to each of the expenses including, but not limited to, archiving and disputing. Additionally, when viewing the payments module, both reoccurring and additional expenses are payable and sortable by various dropdowns including, but not limited to, status, dates paid, payee name and type, and category. A variety of actions can be applied to each of the payment items including, but not limited to, paying, disputing, and selecting for additional information or options. The payments module enables a mother of child to be paid directly or a third-party merchant or business or individual to be paid directly by either of the parents.

In one embodiment, the payments module includes a method of linking to one or more external financial institution accounts including, but not limited to, a Cash App, PayPal or Venmo financial account. The method includes giving the system access and permission to retrieve various information including, but not limited to, name, email, address, account information from the external financial institutions. The method starts a preapproval process to enable payments to or from an external financial institution, logs back into the financial institution, prompts for review and approval of account information, and then completes the process of adding information to the payment module of the system. Accordingly, the father optionally uses the payments module of the system to send child support funds to the mother via an external/third-party financial institution account. Similarly, the putative father optionally uses the payments module of the system to send payments to third parties via an external/third-party financial institution account. The foregoing payment transactions via one or more external/third-party financial institution account, having been initiated through the payments module of the system, are credited to the putative father and are stored on the primary database and shared calendar similar to the manner in which debit card charges are stored on the primary database and shared calendar, as described above.

In one embodiment, the payments module includes a method by which the mother optionally pays third parties via an external/third-party financial institution account. In one embodiment, the putative father may restrict the mother's ability to pay via an external/third-party financial institution account. The purpose of such restriction is to provide the putative father tighter control over how the child support funds are utilized.

In one embodiment, the payments module includes a method by which the mother cashes out the DD Tokens loaded onto the secondary debit card. In one embodiment, the putative father may enable or disable the cash-out feature. The purpose of such restriction is to provide the putative father tighter control over how the child support funds are utilized. In one embodiment, the mother cashes out the DD tokens loaded to the secondary debit card via the above-described external cryptocurrency payment gateways. In another embodiment, the mother cashes out the DD tokens loaded to the secondary debit card via the above-described internal cryptocurrency payment gateway.

When viewing the documents module, both random documents and receipts are displayed and editable/creatable. Documents serve to store, archive, and share information specific and relevant to the child(ren) or legal aspects between the mother of a child and putative father. Random documents include, but are not limited to, agreements, certifications, contracts, and report cards of the child. Folders are creatable and editable to further organize the various documents by categories and types. Various versions are produced for each of the documents and receipts for easy viewing/sorting. Smaller versions of the document display a small sized image of a cover page of the document, a document name, a date added, a category, and a link to open a full version of the document. Smaller versions of the receipt display a small sized image of a cover page of the receipt, a date, a merchant name, an amount, a category, and a link to open a full version of the receipt.

When viewing the account management module, various sections are displayed including, but not limited to, children, mothers, a putative father, pre-legal child support agreements, contracts, payees, and merchants. Key details for each section are listed in an organized and easily viewable fashion. Additional data is creatable to each of these sections which are also editable. One of ordinary skill in the art readily recognizes that a variety of data can be editable for the children, mothers and putative father including, but not limited to, name, address, city, relationship, employment status, employer name, and contact information and that would be within the spirit and scope of the present invention.

When viewing the registration wizard, key pieces of information are initially gathered from the parties involved in the pre-legal child support dispute including, but not limited to, name, address, children names, gender, and dates of birth, support agreements such as pre-legal child support, healthcare, parent/guardian information, and payment/financial information. This enables the pre-legal child support management system to automatically compile information related to the pre-legal child support dispute and to begin leveraging the information to fill out various future legal forms that may be arise in the future. When a party logs in for the first time, they can provide the other party's email address/contact information so that they are automatically prompted to sign up as well. When the mother of a child sets up an account, the system will prompt the mother to link her account to the putative father's account, the shared calendar set up by the putative father and at least some of the agreements/contracts executed by the putative father. If the mother has multiple children from multiple putative fathers, the system prompts the mother to link her account to each of the putative father's registered on this system who follow the putative father account set up process as described above (and below).

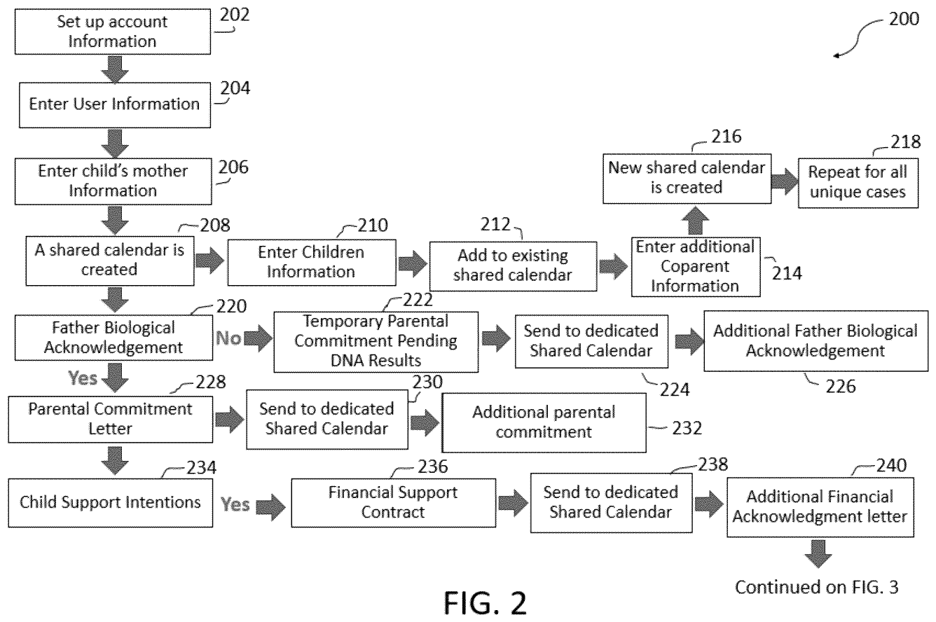

FIG. 2 illustrates a method 200 for setting up accounts in the pre-legal child support management system in accordance with an embodiment. The method 200 includes setting up account information, via step 202, entering party/putative father (primary user) information, via step 204, and entering other party/mother of the child information via step 206. Setup shared calendar method for communication between both parties/putative father and mother of the child, via step 208. A putative father enters child(ren) information via step 210, A putative a father assigns child(ren) to shared calendar, via step 212.

A putative a father can add additional coparent (if needed) via step 214. A putative a father can create an additional shared calendar (if needed) via step 216. For each additional case being managed, steps 214 and 216 are repeated, via step 218. The method 200 prompts whether more than one party/parent is managing support, via step 218. A putative father can acknowledge if he is the biological father of a child, via step 220. A putative father can express unsureness of his biological relations to a child, signing a temporary parental commitment contract until paternity is established, via step 222. A putative father can send a temporary parental commitment contract to a created shared calendar, via step 224. A putative father can create additional temporary parental commitment letters (if needed) sending them other shared calendars, via step 226. A putative father can complete a parental commitment contract accepting his role as a parent, via step 228. A putative father can send a parental commitment contract to a created shared calendar, via step 230. A putative father can create additional parental commitment letters (if needed) sending them other shared calendars, via step 232. A putative father can opt to provide financial child support to the mother of a child, via step 234. A putative father can create a financial support contract, stating terms of pre-legal child support (e.g., amount of support, frequency of payments, form of payments, and whether reoccurring expenses and/or additional/incremental expenses are covered), via step 236. A putative father can send a financial support contract to a created shared calendar, via step 238. A putative father can create additional financial support contracts (if needed) sending them other shared calendars, via step 240. In another embodiment, rather than using a financial support contract, the aforementioned terms of pre-legal child support may be entered into the DocuDad system using any known convention in the art.

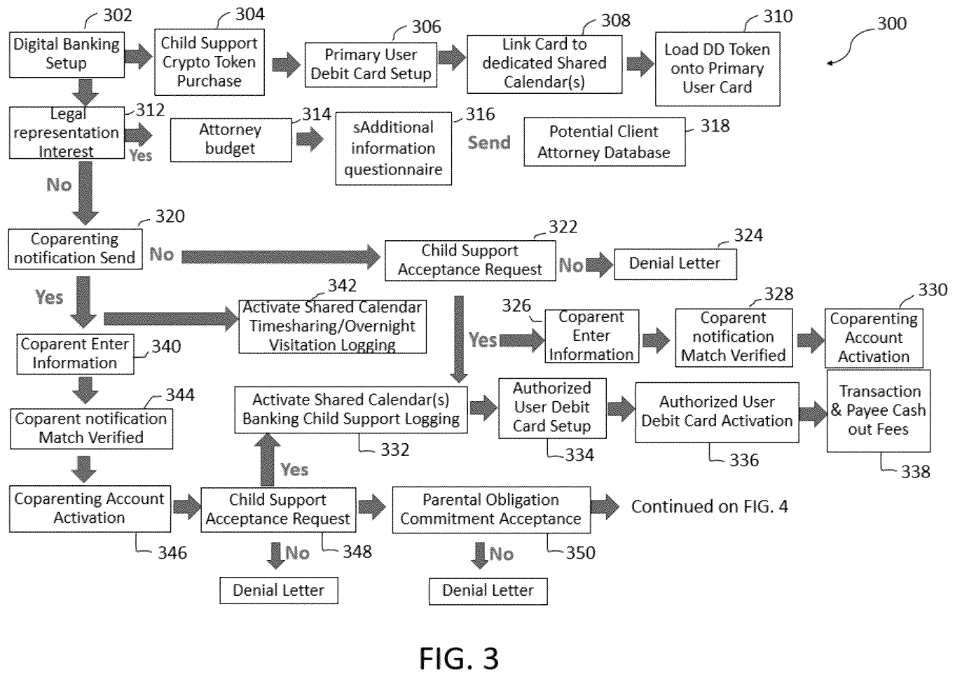

FIG. 3 illustrates a method 300 for further setting up accounts in the pre-legal child support management system in accordance with an embodiment. The method 300 includes setting up an internal banking account via step 302. Primary account holder (i.e., the putative father) can purchase DocuDad (DD) tokens for child support purposes, via step 304. Primary account holder can set up a (primary) debit card with banking account, via step 306. Primary account holder can link debit card with shared calendar(s), via step 308. Primary account holder can load DD token onto debit card for expenses (reoccurring and/or additional/incremental, as defined above) including, but not limited to, pre-legal child support payments, via step 310.

The pre-legal child support management system inquiries whether a putative father has interest in seeking legal counsel, via step 312. A putative father can select a budget range for legal counsel, via step 314. (Additional filter selection may include, but is not limited to, a proximity search and a system attorney rating or imported attorney rating search.) A putative father completes DocuDad questionnaire detailing the history and relationship with mother of the child, via step 316. The pre-legal child support management system enters putative father into a “potential client-attorney database” dedicated to attorneys bidding on putative father's profile, via step 318. The potential client-attorney database is part of the primary database. Attorneys register with the system and create a user account and an attorney profile, the attorney profile being searchable and visible to other users of the system (e.g., a putative father). Registered attorneys will have limited access to potential client's profiles within their cities or zip codes. The DocuDad system will offer attorney referral services.

The pre-legal child support management system sends the other party or mother of the child notification of putative father's request to effectively coparent, via step 320. If the mother of a child denies request to coparent, the pre-legal child support management system sends a child support acceptance request on behalf of the putative father, via step 322. Upon further denial from other party or mother of a child, the pre-legal child support management system issues a denial letter to the putative father via the central repository, via step 324 (and thereafter the process terminates). Upon acceptance of the pre-legal child support management system's notification request to accept child support on behalf of putative father, the mother of a child enters personal information, via step 326. The pre-legal child support management system verifies a match between the mother of a child and putative father, via step 328. The pre-legal child support management system activates the matched account between the mother of a child and putative father, sending notification to each party, via step 330.

Upon coparenting account activation, the pre-legal child support management system links the internal banking account with the shared calendar to begin logging expenses and overnight visitations the child spends with a putative father and mother of the child, via step 332. The system sets up a secondary debit card for the mother of a child upon internal banking notification, via step 334. The method 300 includes giving the pre-legal child support management system access and permission to retrieve various information including, but not limited to, name, email, address, account information from the internal banking account, via step 334. The pre-legal child support management system activates the secondary (authorized user) debit card and starts a preapproval process to enable payments for the secondary (authorized user) debit card upon review and approval of account information, via step 336. The pre-legal child support management system accesses transaction interchange fees as well as payee cash out fees, via step 338. The method 300 returns to steps 340-348 to setting up and activating shared calendar(s) and coparent internal banking debit card account(s) (i.e., the internal bank account and linked primary and secondary debit cards described above). In particular, method 300 includes setting up account information, entering putative father information, via step 340, and entering other party/mother of the child information, via step 342. Setup shared calendar method for communication between both parties/putative father and mother of the child, via step 344. A putative father enters children information, via step 346. A putative father assigns children to shared calendar. A putative father can add additional coparent creating additional shared calendar (if needed), via step 348. The pre-legal child support management system prompts the mother of a child to accept, complete and sign the parental obligations commitment contract, previously completed, and signed by the other party/putative father, via step 350. The pre-legal child support management system issues a denial letter to putative father upon mother of the child refusing to the terms of the parental obligations commitment contract (and thereafter the process terminates).

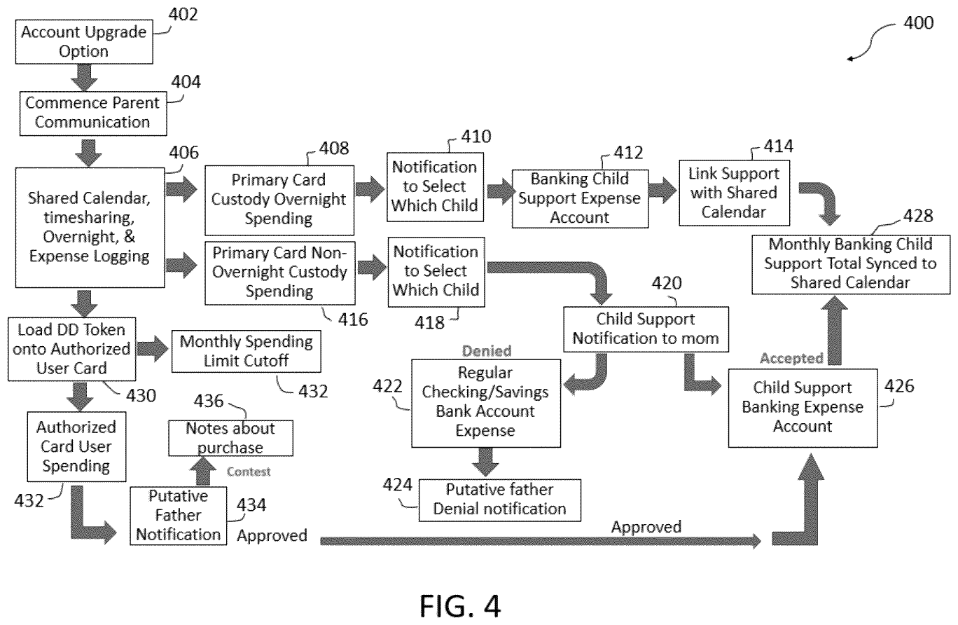

FIG. 4 illustrates a method 400 for managing reoccurring expenses in accordance with an embodiment. The method 400 includes upgrading DocuDad app account option, utilizing all features and services, via step 402. Each party can now begin communicating with the other party including, but not limited to, the pre-legal child support management system, SMS messaging and email, via step 404. A putative father and mother of a child can enter time sharing details including, but not limited to, overnight visitations each party spends with the child, via step 406. The method 400 interconnectedness of the pre-legal child support management system syncs both primary debit card and secondary (authorized user) debit card expense type based on overnight versus non-overnight visitations. During overnight visitations with the child, each transaction expense by a putative father is documented via primary debit card, via step 408. The pre-legal child support system sends a notification by message to a putative father to select which child(ren) for which expense(s) were made, via step 410. When a child or children are selected, via automated data collection, and saved, the expense(s) details are automatically synced through data integration methods within the pre-legal child support management system, such that the information in the internal banking system is synced with the primary database and the shared calendar. Expenses are allocated to a child support expense account, via step 412. All expenses are then populated onto the dedicated shared calendar, at predetermined intervals (i.e., any chosen frequency, such as, but not limited to, bi-weekly or monthly), via step 414.

During non-overnight visitations with the child, each transaction expense by a putative father is documented via primary debit card, via step 416. Upon the completion of each transaction, the method 400 sends prompts for the putative father to select which child(ren) for which expense(s) where made, via step 418. The pre-legal child support management system sends an automated notification message and email notification to the other party or mother of the child to verify if the newly added expense(s) are for child support purposes, via step 420. If the mother of the child denies child support purposes, the pre-legal child support management system allocates the expense to a non-child support expense in the internal banking system, via step 422. A denial notification is sent the putative father, via step 424. If the mother of the child agrees and accepts child support via notification message or text message for reoccurring expense(s), the pre-legal child support management system allocates the expense(s) to a child support expense account inside of the internal banking system via step 426. The method 400 includes a monthly synchronization of the putative father's child support expense account from the internal bank account to the shared calendar, each party is notified, via step 428. A putative father can exchange fiat money for DDT Tokens on the pre-legal child support management system platform for the purposes of loading a desired amount onto a secondary (authorized user) debit card, via step 430. An authorized user can make pre-approved purchases on DDT debit card, via step 432. The pre-legal child support management systems sends a notification to the primary account holder for verification of child support expense via message or text, via step 434. Notes can be documented and attached to purchases in the event of a primary account holder contesting an expense made by the authorized user, via step 436. The method 400 returns to steps 426-428 to allocate all uncontested expenses to a child support expense account inside of the internal banking system.

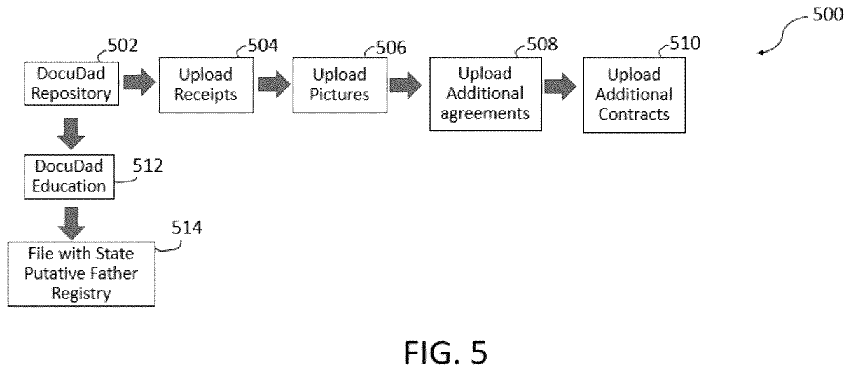

FIG. 5 illustrates a method 500 for managing additional expenses and documentation in accordance with an embodiment. The method 500 includes uploading documents, and verifying details automatically provided via data integration methods in a repository, via step 502. Each party uploading receipts for pre-legal child support expenses via 504. Each party can upload pictures of child(ren) activities and parental engagement via step 506, Each party can upload/update additional agreements including, but not limited to, text messages, SMS messaging, and email via 508. Each party can update additional contracts in the pre-legal child support management system including, but not limited to, text messages, SMS messaging, and email via step 510. Accessing the dashboard and parental educational modules, via step 512. The method 500 prompts whether a putative father wishes to file with a Putative Father's Registry, via step 514.

As described above, the system and method allow for managing the exchange of money and the payment of pre-legal child support between at least two parties, a putative father and the mother of a child. By creating a pre-legal child support management system that includes, but is not limited to, a web-based social platform, the financial security provided to children via child support payments covering reoccurring and additional expenses is streamlined. The pre-legal child support management system operates without government worker interference and provides tools that automate pre-legal child support information population into the pre-legal child support management system and that enable both parties/putative father and mother of a child to manage, track, and make direct payments of all expenses in a timely and transparent fashion.

A person of ordinary skill in the art readily recognizes that the pre-legal child support management system as described herein can be adapted or reconfigured to manage post-legal child support payments. In one embodiment, for example, upon issuance of a court-ordered child support order, a father can execute a new financial support contract (described above), which, in this instance, sets forth an amount of post-legal child support to be paid. Similarly, upon issuance of a court-ordered custody and visitation order, a father can execute a parental commitment contract (described above), which, in this instance, sets forth a post-legal visitation schedule. The foregoing financial support contract and parental commitment contract would then be linked to the non-custodial parent user account and custodial parent user account, to the shared calendar, etc., as described above. Alternatively, the users (i.e., the formerly putative father and the mother) can create new user accounts or add a new support case(s) to their existing user accounts, similar to adding additional children for the purpose of pre-legal child support, as described above. In another embodiment, the system is configured to use the court-ordered child support order as a substitute for a financial support contract, and the court-ordered custody and visitation order as a substitute for the parental commitment contract. The foregoing two substitute orders would then be linked to the non-custodial parent user account and custodial parent user account, to the shared calendar, etc., as described above.

A system and method for facilitating pre-legal child support management has been disclosed. Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on a non-transitory computer storage medium for execution by, or to control the operation of, data processing apparatus. Alternatively, or in addition, the program instructions can be encoded on an artificially generated propagated signal, e.g., a machine generated electrical, optical, or electromagnetic signal, that is generated to encode information for transmission to suitable receiver apparatus for execution by a data processing apparatus. A computer storage medium can be, or be included in, a computer readable storage device, a computer readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Embodiments of the subject matter described in this specification can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Thus, particular embodiments of the subject matter have been described.

What is claimed is:

1. A system for managing prelegal child support payments, the system comprising:
at least one processor configured to communicate with at least one computing device over a communication network; and
a memory, in which the memory stores instructions which, when executed by the at least one processor, direct the at least one processor to:
issue a debit card to a custodial parent having a custodial parent user account, wherein the custodial parent debit card is linked to a system bank account associated with, and managed from, a non-custodial parent user account.

2. The system of claim 1, wherein the memory further stores a modifiable list comprising at least one of restricted merchants, merchant types, and dates and times of purchase, wherein the instructions further direct the at least one processor to prevent completion of purchases with the custodial parent debit card according to restrictions set forth in the modifiable list, and wherein the non-custodial parent user account has access to modify the modifiable list.

3. The system of claim 1, wherein the memory further stores a list of registered merchants, and wherein the instructions further direct the at least one processor to monitor purchases made with the custodial parent debit card at each of the registered merchants, create a spending baseline associated with each of the registered merchants over a predetermined amount of time, compare future purchases made with the custodial parent debit card at each of the registered merchants after the predetermined amount of time, and send an alert to the non-custodial parent user account when a purchase falls outside the spending baseline.

4. The system of claim 1 further comprising a blockchain, and wherein the system bank account is funded with system-issued crypto tokens.

5. The system of claim 1, wherein the custodial parent debit card has a monthly spending limit, and wherein the instructions further direct the at least one processor to send a request for additional funds to the non-custodial parent user account when usage of the custodial parent debit card exceeds the monthly spending limit.

6. The system of claim 1, wherein the instructions further direct the at least one processor to store, on a database in the memory, an amount of child support to be provided by the non-custodial parent for a child, calculate a child support balance after deducting each purchase made with the custodial parent debit card, and report the child support balance to the non-custodial parent user account and the custodial parent user account at predetermined intervals.

7. A system for managing prelegal child support payments, the system comprising:
at least one processor configured to communicate with at least one computing device over a communication network; and
a memory, in which the memory stores instructions which, when executed by the at least one processor, direct the at least one processor to:
issue a debit card to a non-custodial parent having a non-custodial parent user account, wherein the non-custodial parent debit card is linked to a system bank account associated with, and managed from, the non-custodial parent user account.

8. The system of claim 7, wherein the instructions further direct the at least one processor to:
store, on a database in the memory, an amount of child support to be provided by the non-custodial parent to a custodial parent having a custodial parent user account, and a visitation schedule for the non-custodial parent, the visitation schedule comprising overnight visitation dates and non-overnight visitation dates;
create a shared calendar having the visitation schedule and link the shared calendar with the non-custodial parent user account and the custodial parent user account;
designate purchases made with the non-custodial parent debit card on the overnight visitation dates as child support expenses;
send an approval or denial request to the custodial parent user account for purchases made with the non-custodial parent debit card on the non-overnight visitation dates, wherein the approved non-overnight visitation date purchases are designated as child support expenses and the denied non-overnight visitation date purchases are designated as non-child support expenses;
calculate a child support balance after deducting the child support expenses; and
update the shared calendar to list each purchase and store the child support balance, wherein the shared calendar reports the child support balance to the non-custodial parent user account and the custodial parent user account at predetermined intervals.

9. The system of claim 8, wherein the memory further stores a modifiable list comprising at least one of permitted merchants, merchant types, and dates and times of purchase, wherein the instructions further direct the at least one processor to complete purchases with the non-custodial debit card on the non-overnight visitation dates according to permissions set forth in the modifiable list, and wherein the custodial parent user account has access to modify the modifiable list.

10. The system of claim 8, wherein the instructions further direct the at least one processor to:
issue a debit card to the custodial parent, wherein the custodial parent debit card is linked to the system bank account; and
designate purchases made with the custodial parent debit card as child support expenses; and
wherein the child support balance is calculated after deducting the child support expenses.

11. The system of claim 10, wherein the memory further stores a modifiable list comprising at least one of restricted merchants, merchant types, and dates and times of purchase, wherein the instructions further direct the at least one processor to prevent completion of purchases with the custodial parent debit card according to restrictions set forth in the modifiable list, and wherein the non-custodial parent user account has access to modify the modifiable list.

12. The system of claim 10, wherein the memory further stores a list of registered merchants, and wherein the instructions further direct the at least one processor to monitor purchases made with the custodial parent debit card at each of the registered merchants, create a spending baseline associated with each of the registered merchants over a predetermined amount of time, compare future purchases made with the custodial parent debit card at each of the registered merchants and send an alert to the non-custodial parent user account when a purchase falls outside the spending baseline.

13. The system of claim 7 further comprising a blockchain, and wherein the system bank account is funded with system-issued crypto tokens.

14. The system of claim 8, wherein the instructions further direct the at least one processor to store, on the database, a separate amount of child support and a separate visitation schedule for each one of two or more children of the non-custodial parent, and create a sub-account in the system bank account for each one of the two or more children, and assign each of the child support expenses to the relevant sub-account.

15. The system of claim 10, wherein the instructions further direct the at least one processor to store, on the database, a separate amount of child support and a separate visitation schedule for each one of two or more children of the non-custodial parent of which the custodial parent is a co-parent, and create a sub-account in the system bank account for each one of the two or more children, and assign each of the child support expenses to the relevant sub-account.

16. A method for managing prelegal child support payments, the method comprising:
controlling, by at least one processor of a server configured to communicate with at least one computing device over a communication network, the step of:
issuing a debit card to a custodial parent having a custodial parent user account, wherein the custodial parent debit card is linked to a system bank account associated with, and managed from, a non-custodial parent user account.

17. The method of claim 16, further comprising:
controlling, by the at least one processor, the step of:
issuing a debit card to a non-custodial parent having a non-custodial parent user account, wherein the non-custodial parent debit card is linked to a system bank account associated with, and managed from, the non-custodial parent user account.

18. The method of claim 17, further comprising:
controlling, by the at least one processor, the steps of:
storing, on a database in a memory, an amount of child support to be provided by the non-custodial parent to the custodial parent having a custodial parent user account, and a visitation schedule for the non-custodial parent, the visitation schedule comprising overnight visitation dates and non-overnight visitation dates;
creating a shared calendar having the visitation schedule and linking the shared calendar with the non-custodial parent user account and the custodial parent user account;
designating purchases made with the non-custodial parent debit card on the overnight visitation dates and purchases made with the custodial parent debit card as child support expenses;
sending an approval or denial request to the custodial parent user account for purchases made with the non-custodial parent debit card on the non-overnight visitation dates, wherein the approved non-overnight visitation date purchases are designated as child support expenses and the denied non-overnight visitation date purchases are designated as non-child support expenses;
calculating a child support balance after deducting the child support expenses; and
updating the shared calendar to list each purchase and store the child support balance, wherein the shared calendar reports the child support balance to the non-custodial parent user account and the custodial parent user account at predetermined intervals.

19. The method of claim 18, further comprising:
controlling, by the at least one processor, the steps of:
storing, on the memory, a modifiable list comprising at least one of restricted merchants, merchant types, and dates and times of purchase, the non-custodial parent user account having access to modify the modifiable list; and
preventing completion of purchases with the custodial parent debit card according to restrictions set forth in the modifiable list.

20. The method of claim 19, further comprising:
controlling, by the at least one processor, the steps of:
storing, on the memory, a list of registered merchants;
monitoring purchases made with the custodial parent debit card at each of the registered merchants and creating a spending baseline associated with each of the registered merchants over a predetermined amount of time;
comparing future purchases made with the custodial parent debit card at each of the registered merchants after the predetermined amount of time; and
sending an alert to the non-custodial parent user account when a purchase falls outside the spending baseline.
